(19) United States
(12) Patent Application Publication
(10) Pub. No.: US 2023/0184697 A1
(43) Pub. Date: Jun. 15, 2023

(54) COMPUTER-IMPLEMENTED METHOD FOR MEASURING AN OBJECT

(71) Applicant: Volume Graphics GmbH, Heidelberg (DE)

(72) Inventors: Matthias Flessner, Heidelberg (DE); Christoph Poliwoda, Heidelberg (DE); Sören Schüller, Heidelberg (DE); Thomas Günther, Heidelberg (DE); Daniela Handl, Heidelberg (DE); Sven Gondrom-Linke, Heidelberg (DE); Christof Reinhart, Heidelberg (DE)

(21) Appl. No.: 17/923,206

(22) PCT Filed: Apr. 28, 2021
(86) PCT No.: PCT/EP2021/061099

§ 371 Date: Nov. 3, 2022

(30) Foreign Application Priority Data
May 11, 2020 (DE) 10 2020 112 647.6

(51) Int. Cl. G01N 23/046

(52) U.S. Cl. CPC G01N 23/046; G01N 2223/303

(57) ABSTRACT

Described is a computer-implemented method for measuring an object comprising the following steps: determining measurement data by means of a device for measuring the object, wherein the measurement data generates a digital representation of the object with a plurality of image data of the object; and carrying out the following steps at least before the step of determining measurement data has ended: analyzing at least one dimensional measurement variable of at least one part of the digital representation of the object, determining at least one conformity result relating to the analyzed part of the digital representation of the object, wherein the conformity result indicates to what extent the analyzed at least one dimensional measurement variable fulfils at least one predefined conformity criterion for the object, and adapting the step of determining measurement data taking the at least one conformity result into account.

The invention relates to a computer-implemented method for measuring an object.

In the mass production of components, the individual components are subject to manufacturing tolerances and possible defects. To check whether the tolerances are observed and whether defects are present in the component, measurements are carried out on the components. A component to be measured is initially unknown at the time of measurement. This can apply to the entire geometry of the component or just parts of the geometry of the component. Even with a known target geometry, the component to be measured will have unknown deviations from this, and these deviations often need to be checked.

It is known to define how the entire determination of the measurement data will be performed before the measurement is started. However, repeated measurements may be necessary if regions of the component that are required to determine the geometry of the component have not been acquired with sufficiently high quality during the initial measurement.

The object of the invention is therefore to provide a computer-implemented method which has an increased efficiency.

The main features of the invention are specified in claims 1 and 15. Configurations form the subject matter of claims 2 to 14.

In a first aspect, the invention relates to a computer-implemented method for measuring an object, the method comprising the following steps: determining measurement data by means of a device for measuring the object, wherein the measurement data generates a digital representation of the object with a plurality of image data of the object; and carrying out the following steps at least before the step of determining measurement data has ended: analyzing at least one dimensional measurement variable of at least one part of the digital representation of the object; determining at least one conformity result relating to the analyzed part of the digital representation of the object, wherein the conformity result indicates to what extent the analyzed at least one dimensional measurement variable fulfils at least one predefined conformity criterion for the object; and adapting the step of determining measurement data taking the at least one conformity result into account.

The invention provides a computer-implemented method for measuring an object which, during the determination of the measurement data, uses information resulting from the determination of the measurement data to affect the determination of the measurement data. This information can be obtained from an analysis of at least one dimensional measurement variable of the digital representation of the object, with only one part of the digital representation needing to be analyzed. The analysis examines the conformity of at least one dimensional measurement variable of the object with regard to at least one predefined conformity criterion for the object. The resulting at least one conformity result includes information obtained during the measurement of the object. The use of the information, i.e. the conformity result obtained from the determination of the measurement data, can influence the measurement of the object, i.e. the determination of the measurement data of the object, during the ongoing measurement operation of the same object with the step of adapting the step of determining measurement data while taking the at least one conformity result into account. Determining the conformity result and adapting the step of determining measurement data are carried out before the step of determining measurement data is completed. If the conformity result indicates that the predefined conformity criteria for the object are certainly not met, the ongoing measurement operation, i.e. the determination of the measurement data, can therefore be aborted as a further measurement would no longer change this conformity result. The rest of the object is thus no longer measured and the device for measuring an object can be used for another measurement on another object before the normal measurement period expires for a complete determination of the object measurement data. Alternatively, the conformity result can indicate that the measured object definitely meets at least one predefined conformity result. Even in this case, the measurement of the object can be terminated prematurely, as a further measurement would no longer change the conformity result. The device for measuring an object can therefore be used for a further measurement on another object at an earlier stage. In addition, the conformity result may indicate even before the end of the determination of the measurement data that a further examination with a different measurement method may be necessary to obtain a reliable conclusion as to the conformity of the object. This means that the current measurement can also be terminated and further measurement data can be obtained with other measurements. In this case also, time is saved because before the end of the complete measurement by means of the device for measuring the object, the necessary further measurement can be carried out with different methods and devices. The computer-implemented method thus provides an adaptive measurement of the object that uses time resources efficiently. The time gained can then be used e.g. to increase the quality of the measurement data of the measurements.

In one example, the measurement can be a radiographic measurement, e.g. using X-ray radiation. In another example, the measurement can be an optical measurement, e.g. photogrammetry or strip projection. In another example, it may involve a tactile measurement or another type of measurement.

In a radiographic measurement, the analysis can be performed on the basis of 2D radiographic images, a reconstructed 3D volume, or both in combination.

The digital representation of the object can be a volumetric representation, a sectional representation, a projection representation and/or a surface representation. The volume representation can be derived e.g. from a plurality of projection representations. The surface representation can be derived e.g. from a volumetric representation or, in the case of photogrammetry and strip projection, from a plurality of camera images or measurement images.

The radiographic measurement is carried out by means of a device that determines measurement data from a radiographic geometry around the object. The object is irradiated from different radiation directions. A radiographic geometry describes the direction in which the object is irradiated, but also the position of the irradiated region and the magnification. Quite generally, the radiographic geometry can be described by the position of the X-ray source and the detector, viewed relative to the measurement object. This results in nine geometric degrees of freedom: three degrees of freedom each for the tube and the detector for the translation and three degrees of freedom for the detector for the rotation. A radiographic geometry can be defined with respect to the measurement object, but also with respect to the device for measuring the object.

The conformity result may have an uncertainty, e.g. at the beginning of the determination of the measurement data, if—using the example of the radiographic measurement—only a few projections were recorded, using the example of photogrammetry or strip projection only a few measurement images were recorded, or if only a few measurement points were recorded in the case of a tactile sensor.

Analyzing at least one dimensional measurement variable of at least one part of the digital representation of the object can be understood to mean e.g. a reconstruction, segmentation and/or surface determination of the measurement data, which can be followed by a further analysis. In doing so, e. g. a dimensional analysis can be carried out, in particular based on dimension, shape, position, ripple, roughness, wall thicknesses, target-actual comparison of defined geometries or in defined regions, followed by a defect analysis, in particular for pores, voids, inclusions, cracks, porosities or microstructure disaggregations, and/or a material analysis, in particular a fiber composite analysis or a foam structure analysis. Alternatively or additionally, it is possible to perform a detection of the surface, a detection of the interior of the component, i.e. of the material, or an analysis for completeness in the case of assemblies, e.g. for a missing element.

Different approaches can be chosen to perform the analysis with regard to these properties, e.g. the evaluation of three-dimensional measurement data obtained from radiographic measurements of an object.

Alternatively or additionally, an evaluation of two-dimensional measurement data can be performed. This means that the radiographic measurements can also be analyzed directly without reconstruction. This can take place directly on unprocessed radiographic images. For this purpose, multiple radiographic images of different radiographic geometries can also be taken into account together.

Alternatively, a reference image can be used to be able to better identify any defects in the images, e.g. a differential image with respect to a radiographic comparison measurement of a previous measurement of a similar object, which can be averaged, or a differential image with respect to a simulation of an at least similar radiographic image of the target geometry. In addition to conventional algorithms for detecting defects in two-dimensional measurements, an artificial intelligence system can also be trained to identify the defects with high reliability. It may be advantageous to use local information from other sensors for the evaluation, in particular ultrasound for defect and other material analyses or optical and tactile sensors for dimensional metrology.

If the preliminary analysis of the measurement data already available is carried out, these can be examined, for example, in particular with regard to the question of whether the required quality of the measurement data has already been achieved, which may not necessarily be carried out globally, but also locally. This can be a global minimum quality of the measurement data specified for the entire measurement volume, or a local minimum quality of the measurement data defined according to the location or a property to be measured. The minimum quality can also be automatically checked on the basis of the measurement variables specified in an evaluation plan, including tolerances if necessary. The position of the current measurement result with respect to the tolerance interval is also determined. If an estimate of the measurement uncertainty, e.g. on the basis of the current quality of the measurement data, but also on the basis of empirical values, is additionally taken into account, it is possible to determine whether the quantity is safely within or outside the tolerance interval. This would allow a reliable conclusion about the required quality of the measurement data. If this conclusion cannot be drawn, further information in this region or for this measurement variable will be necessary. If no minimum quality of the measurement data has been defined, either explicitly or implicitly via measurement tasks, the quality of the measurement data can still be analyzed to identify those regions in which the quality of the measurement data is the lowest.

This information can be used to decide whether a further measurement run is still necessary or whether the available information is sufficient to process the defined measurement task. If further information is required, optimized exposure parameters can be determined for the subsequent radiographic images.

A tolerance range that is relevant to the decision about the conformity of the component can be specified. The measurements to be performed are often defined in an evaluation plan.

A conformity criterion can be, for example, a specified tolerance that will be checked.

The part of the digital representation of the object is formed from the measurement data determined so far.

Adapting the step of determining measurement data, taking at least one conformity result into account, may result in optimized imaging parameters. Imaging parameters of a projection can be the radiographic geometry of the projection, and/or setting options that can be set when an object is imaged, such as current, voltage and pre-filtering of the tube, the exposure time, the gain factor, the tube used, e.g. micro- or nanofocus tube, the target used, e.g. reflection or transmission target, the detector used, e.g. area or line detector, or a possible binning of the detector. If energy-selective detectors are used, the choice of energy bins can be a setting option.

The decision whether the measurement task can be processed on the basis of the available information and the determination of the measurement data can thus be terminated and/or whether or where further measurement data is required, can occur in various cases. In the case of a globally or locally defined minimum quality, the determination of the measurement data can be terminated if the quality has been achieved everywhere. In many cases, it is sufficient that a critical quantity of the dimensional measurement is outside the tolerance to treat a measured object as scrap. In these cases, the measurement data can be aborted if a critical quantity is definitely out of tolerance. The measurement results of the remaining variables are then usually no longer relevant to the decision.

For statistical monitoring of the manufacturing process, the determination of the measurement data can be continued despite the option to abort the determination of the measurement data. In this case, the measurement data can continue to be determined until the data has a maximum permitted uncertainty. The measurement data is then no longer used to judge the conformity of the object, but to regulate the manufacturing process.

In order to be able to reliably evaluate an object as good or conformant, i.e. with a positive conformity result, all critical quantities to be tested must normally be within tolerance. As soon as all these variables are reliably within tolerance, the determination of the measurement data can be aborted. More complex and/or combined decision rules are also conceivable in principle.

In many cases, it is therefore necessary to determine the, possibly local, quality of the measured data. In addition, a determination of the local uncertainty from the quality of the measurement data can be carried out, which can be expressed in terms of the determined measurement result and a tolerance, as well as the position of the determined measurement result within this tolerance. In the case of dimensional metrology, the local volume data can be analyzed to detect local uncertainty of the measurement, e.g. to estimate the position of the surface or geometry elements fitted to the surface. In defect analysis and other material analysis techniques, for example, the resolution of the data, e.g. based on the point spreading function, and the noise, e.g. the signal-to-noise ratio, can be used to determine the quality of the measurement data. From this it is possible to deduce whether geometric properties of details of a certain size, e.g. small structures, defects or fibers, can be measured with a certain degree of certainty or uncertainty given the present quality of the measurement data.

In another example of a radiographic measurement, the question may be whether, given the quality of the measurement data, details of the surface of a defined size, which usually cause gray value fluctuations in the measurement data, can be reliably distinguished at all from the gray value fluctuations caused by noise and/or artifacts.

The quality of the measurement data can be further ascertained by analyzing the homogeneity of the data, e.g. to detect strip- or beam-hardening artifacts, as well as other methods.

Furthermore, empirical values can be used for different analyses to estimate the local quality of the measurement data and/or uncertainty. For this purpose, a certain quality of the measured data or uncertainty of the measurement data can be expected if this region has been acquired by a certain number of radiographic images. This can be derived e.g. from the specification of the CT system used.

In the case of a two-dimensional measurement or analysis, an uncertainty can be derived from, for example, imaging parameters such as the size of the X-ray spot or the resolution of the detector. Alternatively or in addition, parameters such as noise or contrast in the radiographic images can be analyzed.

The step of carrying out the following steps at least before the step of determining measurement data has ended, can be performed several times in succession with additional or other measurement data obtained by the step of determining measurement data.

According to one example the step of adapting the step of determining measurement data taking the conformity result into account can comprise the following sub-step: terminating the step of determining measurement data if the conformity result indicates that the analyzed at least one dimensional measurement variable fulfils the entire at least one conformity criterion, or if the conformity result indicates that the analyzed at least one dimensional measurement variable does not fulfil at least one part of the at least one conformity criterion.

This is the case, for example, if measurement variables that are outside the tolerance have been identified, in which case the component is not acceptable. In another example, this may be the case if all measurement variables have been verified to be within tolerance, in which case the component is acceptable. In some cases, this cannot be determined from individual measurement variables, e.g. if there are more complex decision criteria, i.e. conformity criteria, for the conformity result.

It may be provided that the fulfilment and/or non-fulfilment of the conformity criterion is only determined if the fulfilment and/or non-fulfilment is 100% reliable.

For example, the step of determining a conformity result may comprise the following substep: taking at least one uncertainty of the analyzed at least one dimensional measurement variable into account.

The at least one uncertainty of the analyzed at least one dimensional measurement variable can be defined globally for all dimensional measurement variables in the digital representation of the object.

Different types of measurement variables, e.g. circle radii, distances between circle centers, wall thicknesses, positions of individual surface points, can each be assigned different uncertainties.

For example, the step of determining a conformity result may comprise the following additional sub-step: determining at least one uncertainty of the analyzed at least one dimensional measurement variable from a local analysis of the measurement data on which the analyzed at least one dimensional measurement variable is based.

The uncertainty for each measurement variable, e.g. each measured geometry element, can be estimated separately. Quality parameters of the measurement data, on which the analyzed at least one dimensional measure is based, can be determined in order to determine an uncertainty. For example, this may involve the local noise or local resolution of volume data or projection data.

In another example, in the step of determining measurement data by means of a device for measuring the object, a radiographic measurement of the object can be carried out, wherein the step of adapting the step of determining measurement data taking the conformity result into account has the following sub-step: identifying at least one region in the at least one part of the digital representation of the object, wherein in the region the conformity result indicates that it is not possible to determine whether the dimensional measurement variable fulfils or does not fulfil the at least one predefined conformity criterion; modifying a radiographic geometry of the radiographic measurement of the object in the step of determining measurement data, in such a way that further measurement data is determined for the identified at least one region.

In this example, it is possible to identify for which measurement variables or regions no reliable conclusions about conformity are yet possible. The additional radiographic geometry or trajectory is selected in such a way that a more accurate conclusion is enabled for these measurement variables. For example, this can be done such that the corresponding regions in the projections to be imaged are displayed more frequently and/or at a higher geometric magnification.

In addition, the step of adapting the step of determining measurement data taking the conformity result into account can also comprise, for example, the following sub-step: changing at least one setting option of a device for carrying out the step of determining measurement data, taking the modified radiographic geometry into account.

In this example, setting options, in particular voltage, current or exposure time, can be optimized to achieve an ideal quality of the measurement data for the additional radiographic geometry or trajectory.

The sub-step of modifying a radiographic geometry and/or a trajectory of the radiographic measurement of the object in the step of determining measurement data may further comprise, for example, the following sub-substep: modifying the radiographic geometry of the radiographic measurement of the object, avoiding simultaneous radiographic measurement of predefined and/or strongly absorbing regions of the object and of the identified regions of the object determined from the measurement data, in which the conformity result indicates that no conclusion can be drawn as to whether the analyzed dimensional measurement variable fulfils or does not fulfil the at least one predefined conformity criterion.

In this example, it is possible to avoid covering the geometries of the object that or relevant or to be measured with strongly absorbing regions.

In addition, for example in the step of determining measurement data by means of a device for measuring the object, a radiographic measurement of the object can be carried out, wherein the method comprises the following step before the step of determining measurement data: determining at least one calibration value for a device for performing a radiographic measurement for at least one predefined radiographic geometry; wherein the step of determining measurement data has the following sub-step: determining at least one required radiographic geometry; using the at least one predefined radiographic geometry if the at least one predefined radiographic geometry corresponds to the at least one required radiographic geometry or, if none of the at least one predefined radiographic geometries corresponds to the at least one radiographic geometry, a geometry that covers a predefined surrounding region around the required radiographic geometry.

By determining calibration values, previously defined radiographic geometries can be calibrated. They can be used flexibly during the measurement. If multiple predefined radiographic geometries have been identified that cover the predefined surrounding region, in the sub-step of using the at least one predefined radiographic geometry the predefined radiographic geometry that has the greatest overlap with the surrounding region of the required radiographic geometry is used. Alternatively, the predefined radiographic geometry that is closest to the required radiographic geometry in the phase space of the geometric parameters that define the radiographic geometry can be used. Different metrics can be defined here. Furthermore, an interpolation of the calibration values for required radiographic geometries can be carried out between the predefined radiographic geometries if none of the predefined radiographic geometries matches a required radiographic geometry.

According to another example, in the step of determining measurement data by means of a device for measuring the object, a radiographic measurement of the object can be carried out, wherein after the steps of determining measurement data and carrying out the steps of analyzing, determining at least one conformity result and adapting, the method comprises the following step: determining calibration values for a device for carrying out a radiographic measurement by means of at least one radiographic geometry that was used during the step of determining the measurement data; generating an at least partially digital representation of the object from the measurement data by means of the calibration values; and carrying out the steps of analyzing at least one part of the at least partial digital representation of the object and determining at least one conformity result relating to the analyzed part of the at least partial digital representation of the object.

In this case, the radiographic geometries used in determining the measurement data are retrospectively calibrated in order to obtain an improved at least partially digital representation of the object. If calibration values have already been determined prior to the step of determining calibration values for a device for carrying out a radiographic measurement by means of at least one radiographic geometry, which was used during the step of determining the measurement data, then calibration values can be determined again, wherein in particular the radiographic geometry used can be taken into account more strictly.

In addition, for example the step of determining measurement data can be carried out by means of an axial computed tomographic measurement with at least one sequence of at least two groups of at least two radiographic measurements, wherein within a group, the radiographic measurements differ from each other by a radiographic angle to the object, which is equidistant within a predefined tolerance angular range, wherein the radiographic measurements of different groups in the sequence have radiographic angles that are arranged equidistantly between the radiographic angles of the radiographic measurements of other groups within the predefined tolerance angle range.

The geometric calibration performed using an axial CT system is comparatively accurate. This is particularly advantageous for dimensional metrology. However, the choice of radiographic geometries in this case is not as flexible as in robot CT systems. Increasing the density of the irradiation directions, which is constant over the space, makes it possible that complete information, i.e. a 360° coverage, will always tend to be available, so that intermediate results of comparatively high quality can be reconstructed and evaluated. For example, this can be implemented in the order whereby the group of 0° and 180° angles are used first. Then the group of 90° and 270° angles is added. This can be followed by the group of angles of 45°, 135°, 225° and 315°. The next group in the sequence can include the angles 22.5°, 67.5°, 112.5°, 157.5°, 202.5°, 247.5°, 292.5° and 337.5°. Additional groups can then follow, filling in the gaps between the angles already used. This gradually and evenly increases the density of the angles used, improving the quality of the data. The quality of the data can be selected flexibly by the number of groups used.

The step of carrying out the steps: analyzing at least one dimensional measurement variable of at least one part of the digital representation of the object, determining at least one conformity result relating to the analyzed part of the digital representation of the object, wherein the conformity result indicates to what extent the analyzed at least one dimensional measurement variable fulfils at least one predefined conformity criterion for the object, and adapting the step of determining measurement data taking the at least one conformity result into account; can be carried out, for example, while the step of determining measurement data is carried out.

It takes a comparatively long time to carry out the evaluations and to identify optimized imaging parameters or to take a decision as to whether further radiographic images are necessary at all. In the meantime, no updated or optimized imaging parameters are therefore available. Instead of waiting for these calculations to be completed before acquiring further radiographic images, additional images can be acquired during the evaluation. For example, in the time taken for the calculations, ten to twenty additional images can be acquired. However, since there are no optimized acquisition parameters available yet, for example, imaging parameters can be selected that still originate from the last iteration and have a lower optimization than the imaging parameters that will be available after the calculation is complete.

Further, the step of analyzing at least one dimensional measurement variable may comprise the following sub-step, for example: generating a digital representation of the object that contains only those parts of the object in which the at least one predefined conformity criterion is defined, and a predefined surrounding region around the parts of the object.

Thus, only the conformity-relevant regions of the object are used for generating the digital representation of the object. The remaining regions of the object are not represented digitally. This reduces the amount of data for evaluation. Since the simultaneous evaluation of measurement data places great demands on computing power, the reduction of the amount of data to be evaluated is particularly advantageous, since the required computing power is thereby reduced. For this step, a pre-alignment of the measurement data can be carried out, i.e. the measurement data can be provisionally aligned to a target geometry of the object. This can be carried out e.g. on the basis of a one-off, rapid reconstruction. Only those regions in which no reliable conclusion about conformity has yet been possible are reconstructed. Alternatively, or in addition, the entire volume or larger regions can be reconstructed with low resolution and only those regions where the low resolution does not allow for a clear conclusion can be reconstructed in full resolution.

If the type of object in the device for measuring the object is known, the spatial orientation, i.e. the alignment, of the measurement data or the object may be initially unknown. This is relevant, however, in order to be able to start any previously defined radiographic geometries, for example trajectories. For this purpose, the spatial orientation of the object in the device for measuring the object can be determined on the basis of the initial radiographic images and the subsequent radiographic geometries can be started up accordingly.

The step of analyzing at least one dimensional measurement variable may further comprise the following sub-step, for example: identifying a surface position in only the at least one part of the digital representation of the object in which the step of analyzing at least one part of the digital representation of the object is to be carried out.

This means that the digital representation of the object is analyzed only at the positions relevant to the analysis. For this purpose, a pre-alignment of the measurement data can be carried out, e.g. on the basis of a one-off, rapid reconstruction. It is possible for the digital representation to be analyzed only in those regions, e.g. the surface of the object to be determined, in which a reliable conclusion as to conformity has not yet been possible. Alternatively or additionally, the entire surface can be determined with a fast analysis, but this only provides inaccurate data, e.g. for orientation or rough alignment. The specified regions can then be determined accurately. This can further reduce the computing power required for the analysis.

A further aspect of the invention relates to a computer program product having instructions executable on a computer, which when executed on a computer cause the computer to carry out the method as claimed in the preceding description.

Advantages and effects as well as further developments of the computer program product arise from the advantages and effects as well as further developments of the above described method. In this respect, reference is therefore made to the preceding description. For example, a computer program product can mean a data carrier on which a computer program element is stored, that contains instructions that can be executed for a computer. Alternatively, or in addition, a computer program product can also mean, for example, a permanent or volatile data store, such as flash memory or RAM, that contains the computer program element. However, other types of data stores that contain the computer program element are not excluded.

Further features, details and advantages of the invention emerge from the wording of the claims and from the following description of exemplary embodiments on the basis of the drawings. In the drawings:

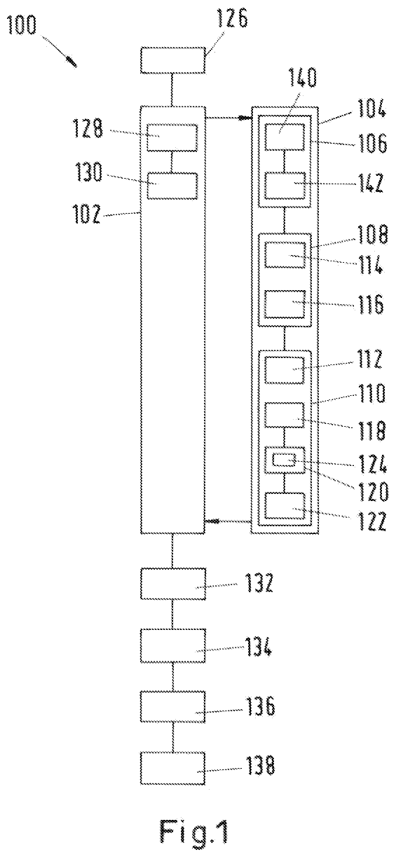

FIG. 1 shows a flow diagram of the computer-implemented method.

The computer-implemented method for measuring an object is referenced below in its entirety with the reference sign 100 as specified in FIG. 1.

In a first step 102, the method 100 comprises determining measurement data by means of a device for measuring the object. The measurement data generates a digital representation of the object, which comprises a plurality of image data of the object. This can be e.g. a two-dimensional representation of the object or a three-dimensional representation of the object. The digital representation of the object can also be derived from the measurement data, e.g. in radiographic measurements by means of tomographic reconstruction.

A further step 104 is carried out at least before the step 102 is completed. Step 104 can interrupt step 102. Alternatively, step 104 can be carried out at the same time as step 102, i.e. during step 102, before step 102 is completed. At this time, not all of the measurement data of the object to be determined has yet been determined. This means that only part of the digital representation of the object exists. Step 104 includes steps 106, 108, and 110.

In step 106 at least one dimensional measurement variable of at least one part of the digital representation of the object is analyzed. This is the part of the digital representation of the object that was previously determined by step 102, since step 102 is not yet completed when step 106 is carried out.

In step 108 at least one conformity result relating to the analyzed part of the digital representation of the object is determined. The conformity result indicates the extent to which the analyzed at least one dimensional measurement variable fulfils at least one predefined conformity criterion for the object. For example, a conformity criterion may be that the dimensions in that part of the digital representation of the object must lie within a tolerance interval. Alternatively or additionally, the conformity criterion may require, for example, that only pores of a predefined number with a predefined size are allowed to be present in the part of the digital representation. Additional conformity criteria are possible.

In step 110, step 102 is adapted according to the conformity result. That is, if the conformity result indicates that the dimensional measurement variable does not fulfil the at least one conformity criterion, the object is treated as scrap and in step 110, step 102 is adapted according to the conformity result. Further determination of measurement data from other parts of the object will no longer change the conformity result in this case.

If the conformity result indicates that the dimensional measurement variable fulfils the at least one conformity criterion, further determination of measurement data from other parts of the object will also no longer affect the conformity result. The object can be treated as a fully compliant object.

In both cases, step 102 can be terminated according to sub-step 112 of step 110. This means that the determination of the measurement data is terminated as soon as the conformity result determines that the conformity criterion cannot be fulfilled with the part of the object measured so far, or that the conformity criterion is met in any case with the part of the object measured so far. Further measurement of the object would no longer change the conformity result, and is therefore unnecessary. The time used for this additional measurement can thus be saved.

In the event that the conformity result indicates that it is not certain whether the conformity criterion is fulfilled or not, the determination of the measurement data is continued in accordance with step 102.

Step 106 can comprise an optional step 140, in which a digital representation of the object is generated that contains only those parts of the object in which the at least one predefined conformity criterion is defined, and a predefined surrounding region around these parts of the object. Only the relevant parts of the object are therefore converted into a digital representation of the object. The parts of the object that are not relevant to the analysis are therefore not included in the digital representation of the object. To this end, a region surrounding the parts of the object is also used to generate the digital representation of the object in order to map and analyze surfaces of the object.

Step 106 may comprise a further optional step 142. In this step, a surface position is determined in the only at least one part of the digital representation of the object. In this part of the digital representation of the object, an analysis will be carried out in step 106. Only those parts of the digital representation of the object are identified in which surfaces are to be analyzed. Parts of the object that do not require analysis are not included in the digital representation of the object.

Step 108 can comprise the optional sub-step 114. At least one uncertainty of the analyzed at least one dimensional measurement variable is taken into account when determining the conformity result. That is, if the conformity result itself indicates that all conformity criteria are fulfilled or that the conformity criterion is not fulfilled, the uncertainty of the analyzed at least one dimensional measurement variable may have a sub-range in which the conformity result or the measurement variable would no longer fulfil or would fulfil the conformity criterion. In this case, the conformity result is not yet deemed to be a reliable conformity result. Only when the conformity criterion is either fulfilled or not fulfilled, even taking into account the uncertainty, will the conformity result be deemed a reliable result.

The at least one uncertainty of the analyzed at least one dimensional measurement variable is defined globally for all dimensional measurement variables in the digital representation of the object. This means that it is irrelevant to the size of the uncertainty which dimensional measurement variable is used. The same uncertainty is assumed for each dimensional measurement variable each time.

Alternatively, step 108 may also comprise the optional sub-step 116 if step 114 is provided. At least one uncertainty of the analyzed at least one dimensional measurement variable is determined from a local analysis of the measurement data. The analyzed at least one dimensional measurement variable is based on this measurement data. A separate uncertainty is thus determined for each dimensional measurement variable, which is taken into account when determining the conformity result.

In the following, it is assumed in this exemplary embodiment that the device for measuring the object performs a radiographic measurement of the object. However, this does not exclude the possibility that in other embodiments of the method the device for measuring the object might determine the measurement data in a different, non-radiographic manner, for example by strip projection, photogrammetry or by means of a tactile sensor.

In an optional step 126, at least one calibration value can be determined for the device for measuring the object. The calibration value is determined for at least one predefined radiographic geometry. This means that either a user or an evaluation plan specifies at least one radiographic geometry that can be used to measure the object.

If the optional step 124 is provided, in step 102 two optional sub-steps 128 and 130 are provided. In sub-step 128, at least one radiographic geometry required for the analysis is determined. The at least one predefined radiographic geometry from step 126 is used in step 130 if it corresponds to one of the required radiographic geometries. This means that, if one of the predefined radiographic geometries is also a required radiographic geometry, this is used when determining the measurement data in step 102. It is sufficient here if the predefined radiographic geometry is arranged around the required radiographic geometry in a surrounding region having a size which is also predefined. This means that slight deviations between the required radiographic geometry and the predefined radiographic geometry can be tolerated. In this case, e.g. the predefined radiographic geometry can also be used to obtain measurement data in step 102. Alternatively, an interpolation can be performed between multiple predefined radiographic geometries to obtain a calibration value for the required radiographic geometry.

Some less complex radiographic geometries, e.g. a circular path of an axial CT system and slight variations thereof, can be reconstructed from a filtered back projection. Iterative methods can be used for radiographic geometries with free trajectories.

Reconstruction methods can also be used, which perform a new reconstruction based on the reconstruction of a previous, e.g. latest, iteration. This is carried out or updated only for the regions affected by the additional radiographic images. In this way, computing time can be saved.

The new evaluation, e.g. a surface determination or analysis, can be carried out for example in the regions where the reconstruction has previously been updated or where the volume data has changed, possibly significantly. This prevents computing time from being used for regions in which no new measurement data is available.

After steps 102 and 104 are completed, the following optional steps 132, 134, 136, and 138 may be provided.

In the optional step 132, calibration values for the device for examining objects are determined by means of at least one radiographic geometry. The one or more radiographic geometries used were also used during step 102 to determine the measurement data. This means that a retrospective calibration of the device for examining objects takes place for the at least one radiographic geometry used in step 102 for determining the measurement data.

The calibration values are used in step 134 to generate an at least partial digital representation of the object from the measurement data. Even if a digital representation of the object has already been generated before, in step 134 a new digital representation is generated which is more accurate due to the calibration values.

A part of the new digital representation of the object is analyzed in step 136 and a conformity result relating to it is determined in step 138. This conformity result is more accurate than the conformity result obtained during the determination of the measurement data due to the calibration values. This allows a retrospective correction of the analysis to take place. In this case, the device is calibrated retrospectively with respect to the radiographic geometries used, so that in principle all measurement data can be used for the correction of the analysis. In this way, the conformity result can be changed retrospectively.

Step 110 can include the optional sub-steps 118, 120, and 122.

In sub-step 118 at least one region in the at least one part of the digital representation of the object is determined. In this region, the conformity result indicates that no conclusion can be drawn as to whether the predefined conformity criterion for the analyzed dimensional measurement variable is fulfilled or not. Regions for which a reliable conformity result is available will not be considered in this step.

In sub-step 120, the radiographic geometry in step 102 is modified in such a way that further measurement data for the region determined in step 118 is determined. This can be done while the measurement is running, i.e. while step 102 is being performed. For the determined region in which no reliable conformity result has yet been obtained, further measurement data is therefore collected in order to achieve a reliable conformity result in a further analysis due to the broader base of measurement data.

The sub-step 120 may comprise a sub-substep 124. The radiographic geometry of the radiographic measurement of the object is modified in such a way that strongly absorbing regions of the object and regions of the object for which it has been determined that no conclusion as to conformity is possible, are not scanned simultaneously, or that the strongly absorbing regions of the object do not obscure the regions during the irradiation where it was determined that no conclusion as to conformity is possible. Irradiation of these regions is prevented by modifying the radiographic geometry. The strongly absorbing regions may be predefined or determined from the measurement data. Among other things, this will prevent falsifications or inaccuracies in the measurement data due to beam hardening. Furthermore, the analysis avoids correlations with the regions of the object in which no conclusion as to conformity is possible.

In sub-step 122, at least one setting option of the device used to carry out the measurement of the objects is changed in such a way that the modified radiographic geometry is taken into account.

If the measurement of the object is a radiographic measurement, the measurement can be performed with an axial computed tomography measurement in step 102. The measurement can be carried out in such a way that the density of the radiographic geometries increases after each measurement. Irradiation angles that are equidistant within a tolerance angle range are selected for the radiographic geometries. The measurements are divided into at least two groups. Within a group, the are spaced equidistantly from each other by irradiation angles of the measurements. The angles of the following group are set between the irradiation angles of the previous group. For example, if the first group has the angles 0° and 180°, the angles of the second group are set at 90° and 270°. A third group then has angles of 45°, 135°, 225° and 315°. The following group of this example then includes the angles 22.5°, 67.5°, 112.5°, 157.5°, 202.5°, 247.5°, 292.5° and 337.5°. Further groups then include angles that are also positioned between the existing angles at which radiation measurements have been performed to determine the measurement data.

In this way the density of the angles can be continuously increased. The greater the density of the angles at which a radiographic measurement was performed, the higher the quality of the measurement data usually is. The density of the angles can be increased until a desired quality for the measurement data has been achieved.

The computer-implemented method thus performs a preliminary analysis, which can be implemented in various ways.

In a first example, the data is continuously analyzed and the determination of the measurement data is optimized during the measurement. In this case, the calculations for determining the optimized imaging parameters must be carried out continuously, which requires high computing power. This can also be referred to as an interactive example.

In the case of a radiographic measurement, the analysis of the measurement data could in principle be started after each determination of a projection or after a certain number of projections. However, the analysis of the measurement data will usually take longer than the recording of another radiographic image. Ideally, the measurement data continues to be determined in parallel with the analysis of the measurement data. The new analysis of the measurement data can be started when the previous analysis of the measurement data is complete. The new analysis is then carried out with the additional radiographic images acquired in the meantime. During an analysis of the measurement data, the imaging parameters identified in the previous measurement data analysis are used.

According to another example, for known and in particular for frequently performed measurement tasks it is possible to calculate in advance how the determination of the measurement data or the evaluation plan, including the tolerances to be tested, can be implemented in an optimized manner. This can be referred to as a compiled example.

Depending on whether the predicted quality of the measurement data can be achieved or whether the analysis of the measurement data can be carried out as planned, it is still possible to react during the determination of the measurement data. This can either take place interactively again as described above, or at predefined decision points, possibly with pre-calculated alternative optimized imaging parameters, depending on the result of the analysis.

In another example, mixed forms of the two examples described above are possible.

Step 102 can be terminated by step 110 if one of the following termination criteria is fulfilled.

If no reliable conclusion is reached by the conformance result and no other termination criterion has been reached, the determination of the measurement data is continued. In individual cases, this can lead to a very long measurement time. In order to avoid this, a termination criterion can additionally depend on an estimation of whether it is still possible to reach a reliable conclusion about the conformity of the measured object in a reasonable time. If this is not the case, step 102 can also be terminated and the part can be deemed as not acceptable, for example, or examined with another measurement method. Alternatively or in addition, a maximum time for determining the measurement data can be defined as a termination criterion.

Advantageously, the trajectory can be chosen freely. The device for measuring the object can be e.g. a CT system that enables free trajectories. This can comprise e.g. a robot CT system for at least one of the components: X-ray source and/or detector, and for manipulating objects. Alternatively or additionally, a conventional axial CT system with a rotary table may be provided.

In addition, e.g. an algorithm for reducing artifacts and/or a filter can be used on the measurement data, in particular for radiographic images and/or volume data, to enable or facilitate an evaluation.

Any prior knowledge of the geometry of the object to be measured can be used in the reconstruction, e.g. from a CAD model, from measurements of the object with another sensor, or from measurements of nominally identical objects. This allows reconstruction of a higher quality 3D volume, in particular if a small number of radiographic images is available. Furthermore, iterative reconstruction algorithms can be used to implement this.

It is advantageous if the poses of the X-ray source, the object to be measured and the detector relative to each other are known. In particular in dimensional metrology, the geometric calibration can then be determined with high accuracy and a geometrically exact reconstruction can be carried out, which meets the requirements of dimensional metrology.

The radiographic geometries used and, if applicable, interactively selected during the measurement can be saved and then re-started after the measurement process in order to calibrate them. This can be carried out e.g. with the aid of a suitable calibration body, e.g. a standard (multi-)sphere, which is radiographically scanned. In retrospect, the corresponding exact calibration can therefore be assigned to the radiographic geometries, which makes an exact reconstruction possible.

As an alternative or in addition, certain radiation geometries can be calibrated in advance, e.g. commonly used geometries and/or different geometries distributed over the entire phase space. These can be performed more or less evenly and completely, to obtain a certain flexibility. Exclusively calibrated geometries can then be used during the measurement. For example, if an advantageous radiographic geometry is determined during the measurement, the next calibrated geometry in the surrounding region is selected. It is thus defined in advance which radiation geometries may be used at all for this purpose; which of these can then also be used in individual cases can differ from object to object.

The occurrence of artifacts such as strip artifacts and/or metal artifacts can be predicted, if necessary depending on the radiation geometry. Thus, a radiographic geometry can be selected for determining the measurement data for which these artifacts are least likely to be present in regions where an analysis is to be performed.

Also, when optimizing the imaging parameters, consideration is given to whether certain radiographic geometries exhibit greater uncertainty in the geometric calibration due to the kinematics of the CT system.

For production monitoring, it is important that the measurement results (regardless of the decision about the position within or outside the tolerance) show a specific maximum uncertainty or minimum quality to reveal drifts in the production process. Therefore, it may be necessary to continue a measurement even further until this has been achieved, although the decision about the conformity of the component was already necessary earlier.

The computer-implemented method 100 can be executed by means of a computer program product on a computer. The computer program product has instructions that can be executed on a computer. When these instructions are executed on a computer, they cause the computer to carry out the method.

The invention is not restricted to one of the embodiments described above, but rather may be modified in a variety of ways. All the features and advantages that emerge from the claims, from the description and from the drawing, including structural details, spatial arrangements and method steps, may be essential to the invention both individually and in a wide variety of combinations.

1. A computer-implemented method for measuring an object, wherein the method comprises the following steps:
determining measurement data by means of a device for measuring the object, wherein the measurement data generates a digital representation of the object with a plurality of image data of the object; and
carrying out the following steps, at least before the step of determining measurement data has ended:
analyzing at least one dimensional measurement variable of at least one part of the digital representation of the object;
determining at least one conformity result relating to the analyzed part of the digital representation of the object, wherein the conformity result indicates to what extent the analyzed at least one dimensional measurement variable fulfils at least one predefined conformity criterion for the object; and
adapting the step of determining measurement data taking the at least one conformity result into account.

2. The method as claimed in claim 1, wherein the step of adapting the step of determining measurement data taking the conformity result into account comprises the following sub-step:
terminating the step of determining measurement data if the conformity result indicates that the analyzed at least one dimensional measurement variable fulfils the entire at least one conformity criterion, or if the conformity result indicates that the analyzed at least one dimensional measurement variable does not fulfil at least one part of the at least one conformity criterion.

3. The method as claimed in claim 1, wherein the step of determining a conformity result further comprises the following sub-step:
taking into account at least one uncertainty of the analyzed at least one dimensional measurement variable.

4. The method as claimed in claim 3, wherein the at least one uncertainty of the analyzed at least one dimensional measurement variable is defined globally for all dimensional measurement variables in the digital representation of the object.

5. The method as claimed in claim 3, wherein the step of determining a conformity result comprises the following additional sub-step:
determining at least one uncertainty of the analyzed at least one dimensional measurement variable from a local analysis of the measurement data on which the analyzed at least one dimensional measurement variable is based.

6. The method as claimed in any one of claims 1, wherein in the step of determining measurement data by means of a device for measuring the object, a radiographic measurement of the object is carried out, wherein the step of adapting the step of determining measurement data taking the conformity result into account has the following sub-steps:
identifying at least one region in at least one part of the digital representation of the object, wherein in the region the conformity result indicates that it is not possible to determine whether the dimensional measurement variable fulfils or does not fulfil the at least one predefined conformity criterion; and
modifying a radiographic geometry of the radiographic measurement of the object in the step of determining measurement data, in such a way that further measurement data is determined for the identified at least one region.

7. The method as claimed in claim 6, wherein the step of adapting the step of determining measurement data taking the conformity result into account further comprises the following sub-step:
changing at least one setting option of a device for measuring the objects, taking the modified radiographic geometry into account.

8. The method as claimed in claim 6, wherein the sub-step of modifying a radiographic geometry of the radiographic measurement of the object in the step of determining measurement data has the following sub-substep:
modifying the radiographic geometry of the radiographic measurement of the object, avoiding simultaneous radiographic measurement of predefined and/or strongly absorbing regions of the object and of the identified regions of the object identified from the measurement data, in which the conformity result indicates that no conclusion can be made as to whether the analyzed dimensional measurement variable fulfils or does not fulfil the at least one predefined conformity criterion.

9. The method as claimed in any one of claims 1, wherein in the step of determining measurement data by means of a device for measuring the object, a radiographic measurement of the object is carried out, wherein the method comprises the following sub-steps before the step of determining measurement data:
determining at least one calibration value for the device for measuring the object for at least one predefined radiographic geometry;
wherein the step of determining measurement data has the following sub-steps:
determining at least one required radiographic geometry; and
using the at least one predefined radiographic geometry if the at least one predefined radiographic geometry corresponds to the at least one required radiographic geometry or, if none of the at least one predefined radiographic geometries corresponds to the at least one radiographic geometry, a geometry that covers a predefined surrounding region around the required radiographic geometry.

10. The method as claimed in any one of claim 1, wherein in the step of determining measurement data by means of a device for measuring the object, a radiographic measurement of the object is carried out, wherein after the steps of determining measurement data and carrying out the steps of analyzing, determining at least one conformity result and adapting, the method comprises the following steps:
determining calibration values for a device for examining objects by means of at least one radiographic geometry that was used during the step of determining the measurement data;
generating an at least partially digital representation of the object from the measurement data by means of the calibration values;
analyzing at least one part of the at least partial digital representation of the object; and
determining at least one conformity result relating to the analyzed part of the at least partial digital representation of the object.

11. The method as claimed in claim 1, wherein the step of determining measurement data is carried out by means of an axial computed tomographic measurement with at least one sequence of at least two groups of at least two radiographic measurements, wherein within a group, the radiographic measurements differ from each other by a radiographic angle to the object, which is equidistant within a predefined tolerance angular range, wherein the radiographic measurements of different groups in the sequence have radiographic angles that are arranged equidistantly between the radiographic angles of the radiographic measurements of other groups within the predefined tolerance angle range.

12. The method as claimed in claim 1, wherein the step of carrying out the steps: analyzing at least one dimensional measurement variable of at least one part of the digital representation of the object, determining at least one conformity result relating to the analyzed part of the digital representation of the object, wherein the conformity result indicates to what extent the analyzed at least one dimensional measurement variable fulfils at least one predefined conformity criterion for the object, and adapting the step of determining measurement data taking the at least one conformity result into account; is carried out while the step of determining measurement data is carried out.

13. The method as claimed in claim 1, wherein the step of analyzing at least one dimensional measurement variable further comprises the following sub-step:
generating a digital representation of the object that contains only those parts of the object in which the at least one predefined conformity criterion is defined, and a predefined surrounding region around the parts of the object.

14. The method as claimed in claim 1, wherein the step of analyzing at least one dimensional measurement variable further comprises the following sub-step:
identifying a surface position in only that at least one part of the digital representation of the object in which the step of analyzing at least one part of the digital representation of the object is to be carried out.

15. A non-transitory computer program product that contains instructions that can be executed on a computer, which when executed on a computer cause the computer to carry out the method as claimed in claim 1.
